(19) United States
(12) Patent Application Publication
(10) Pub. No.: US 2008/0062217 A1
(43) Pub. Date: Mar. 13, 2008

(54) INKJET PRINTING APPARATUS AND METHOD FOR INSPECTING COLOR FILTER AND METHOD FOR MANUFACTURING COLOR FILTER PANEL USING THE SAME

(75) Inventors: Yoon-Ho KANG, Yongin-si (KR); Byoung-Joo KIM, Anyang-si (KR); Yi-Seop SHIM, Suwon-si (KR); Kwang-Ho LEE, Seoul (KR); Jae-Jun YU, Gunpo-si (KR); Jang-Sub KIM, Suwon-si (KR); Seong-Gyu KWON, Suwon-si (KR); Chang-Hun KWAK, Suwon-si (KR); Si-Kyoung KIM, Sunnyvale, CA (US); Quanyuan SHANG, Saratoga, CA (US)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/847,726

(22) Filed: Aug. 30, 2007

(30) Foreign Application Priority Data
Sep. 13, 2006 (KR) 10-2006-0088389

(51) Int. Cl. B41J 29/393

(52) U.S. Cl. 347/19

(57) ABSTRACT

An inkjet printing apparatus, a method for inspecting color filters, and a method for manufacturing a color filter panel using the same are disclosed. The inkjet printing apparatus includes a stage on which a substrate is mounted, an inkjet head for jetting color filter ink onto the substrate, and a color coordinate measurement unit spaced apart from the inkjet head to measure color coordinates of color filters.

### CROSS-REFERENCE TO RELATED APPLICATION

This application claims priority from and the benefit of Korean Patent Application No. 10-2006-0088389, filed on Sep. 13, 2006, which is hereby incorporated by reference for all purposes as if fully set forth herein.

### BACKGROUND OF THE INVENTION

1. Field of the Invention

The present invention relates to an inkjet printing apparatus, a method for inspecting a color filter, and a method for manufacturing a color filter panel using the inkjet printing apparatus.

2. Discussion of the Background

An LCD, which is one of the most commonly used flat panel displays, includes two display panels with field generating electrodes formed therein and a liquid crystal layer interposed there between. In an LCD, a voltage is applied to the field generating electrodes to re-align liquid crystal molecules of the liquid crystal layer and thereby control the amount of light transmitted to display images.

In the LCD, one of the two display panels includes color filters for implementing colors.

The color filters include fine patterns for displaying red, green, and blue colors, and the fine patterns can be formed through a photolithography process, which includes coating, exposing, developing, and etching processes. As the size of the substrates increases, more color filters are coated on the substrates, which require a large exposure mask and fabrication facility.

With a large-scale LCD, there are limitations associated with forming color filters through a photolithography process.

Thus, recently, a method for forming color filters through an inkjet printing process has been introduced. The inkjet printing process is a technique for jetting ink solution to certain regions divided by partitions to produce ink-colored images. This technique allows for considerable reductions in manufacturing time and costs because a plurality of color filters, including red, green, and blue color filters, can be colored at one time.

However, when color filters are formed through the inkjet printing process, the amount of ink solution jetted from each nozzle may not be uniform, which may cause display stains, in the form of stripes, on the substrate.

In an effort to solve the problem of non-uniformity in the amount of jetted ink solution, the diameter of each ink drop jetted from each nozzle can be measured and, if there is great deviation, the amount of ink solution jetted from each nozzle can be altered to an average value by adjusting the driving voltage of the nozzle that jets less or more ink solution than other nozzles.

Nonetheless, although the amount of ink solution jetted is uniformly controlled, color characteristics of each pixel may be shown differently due to differences in the surface characteristics of partitions because of their positions and the ink jetting position. These differences in color characteristics may appear as stripe stains.

### SUMMARY OF THE INVENTION

The present invention provides an inkjet printing apparatus.

The present invention also provides a method for inspecting a color filter.

The present invention also provides a method for manufacturing a color filter panel using the inkjet printing apparatus.

Additional features of the invention will be set forth in the description which follows, and in part will be apparent from the description or may be learned by practice of the invention.

The present invention discloses an inkjet printing apparatus including a stage on which a substrate is mounted, an inkjet head to jet ink solution for color filters onto the substrate, and a color coordinate measurement unit spaced apart from the inkjet head to measure color coordinates of the color filters.

The present invention also discloses a method for inspecting a color filter including disposing a substrate on an inkjet printing apparatus having an inkjet head and a color coordinate measurement unit, jetting ink solution onto the substrate, drying the ink solution to form color filters, measuring color coordinates of the color filters with the color coordinate measurement unit, and controlling the amount of ink solution jetted based on the color coordinate information.

The present invention also discloses a method for manufacturing a color filter panel including forming an insulating layer having a plurality of openings on a substrate, disposing an inkjet head over the openings and jetting ink solution, drying the ink solution to form color filters; measuring color coordinates of the color filters, and forming electrodes on the color filters.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic perspective view showing an inkjet printing apparatus according to one exemplary embodiment of the present invention.

FIG. 2 and FIG. 3 are schematic diagrams showing an inkjet head of the inkjet printing apparatus of FIG. 1.

FIG. 4A is a schematic diagram showing a spectrometer of the inkjet printing apparatus of FIG. 1.

FIG. 4B is a flow chart showing the steps of a method for inspecting color filters according to one exemplary embodiment of the present invention.

FIG. 5 is a schematic perspective view showing an inkjet printing apparatus according to another exemplary embodiment of the present invention.

FIG. 6 is a cross-sectional view showing a color filter panel according to one exemplary embodiment of the present invention.

FIG. 7, FIG. 8, FIG. 9, FIG. 10, and FIG. 11 are cross-sectional views showing sequential steps of a method for manufacturing the color filter panel of FIG. 6, according to one exemplary embodiment of the present invention.

FIG. 12 is cross-sectional view showing an LCD including the color filter panel of FIG. 6.

FIG. 13 is a graph showing color coordinate values measured using the inkjet printing apparatus according to one exemplary embodiment of the present invention.

### DETAILED DESCRIPTION OF THE ILLUSTRATED EMBODIMENTS

The present invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

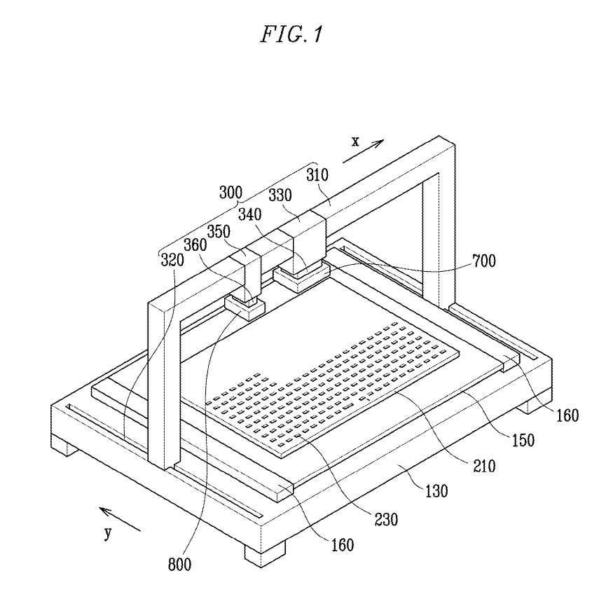

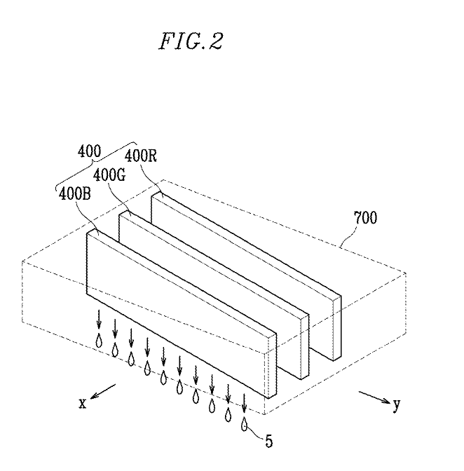

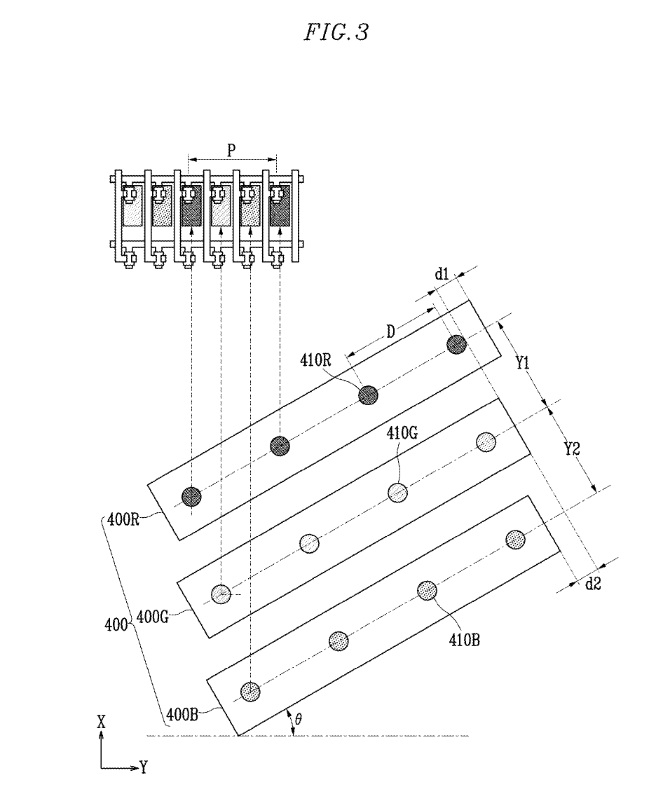

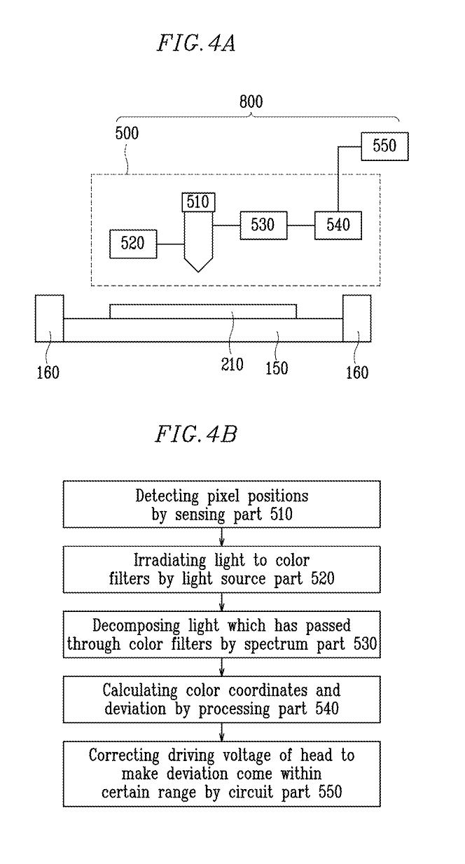

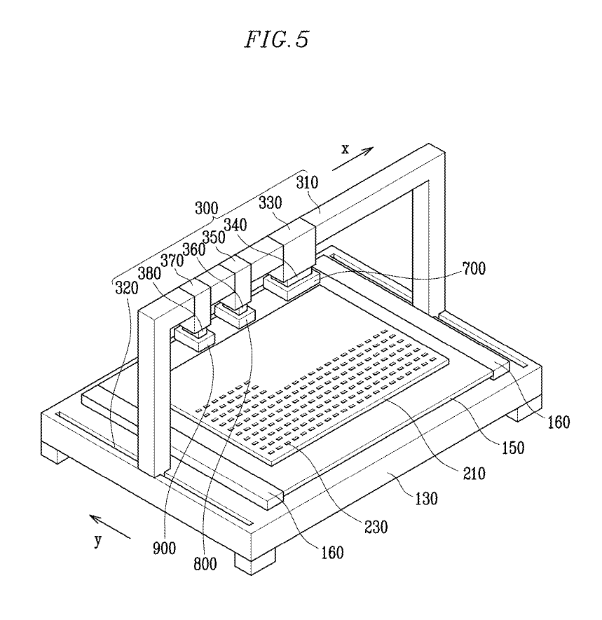

An inkjet printing apparatus according to one exemplary embodiment of the present invention will now be described with reference to FIG. 1, FIG. 2, FIG. 3, and FIG. 4A.

FIG. 1 is a schematic perspective view showing an inkjet printing apparatus according to one exemplary embodiment of the present invention, FIG. 2 and FIG. 3 are schematic diagrams showing an inkjet head of the inkjet printing apparatus of FIG. 1, and FIG. 4A is a schematic diagram showing a spectrometer of the inkjet printing apparatus of FIG. 1

First, as shown in FIG. 1, FIG. 2, and FIG. 3, the inkjet printing apparatus according to one exemplary embodiment of the present invention includes a stage 150 on which a substrate 210 is mounted, a head unit 700 positioned at an upper side of the stage 150, a spectrometer 800 spaced apart from the head unit 700, and a transfer unit 300 for moving the head unit 700 and the spectrometer 800.

The stage 150 is positioned on a support plate 130 and fixed in place by stage driving shafts 160. The stage 150 may be made of a transparent or translucent material that can transmit light or an opaque material that can reflect light, and the stage driving shafts 160 can move the stage 150 in a horizontal or vertical direction within a predetermined range.

The head unit 700 includes a plurality of heads 400 and a plurality of nozzles 41 OR, 410G, and 410B formed on lower surfaces of the heads 400, as shown FIG. 2 and FIG. 3.

The heads 400 include red color heads 400R, green color heads 400G, and blue color heads 400B. With reference to FIG. 2 and FIG. 3, the three heads 400R, 400G, and 400B are separated at equal intervals in parallel. The distance d1 between an end of the red color head 400R and an end of the green color head 400G and the distance d2 between an end of the green color head 400G and an end of the blue color head 400B may be equal. The three heads 400R, 400G, and 400B are sloped at a predetermined angle θ to the ‘y’ direction, and accordingly, the nozzle pitch ‘D’ may be changed to be the same length (D·cosθ) as the pixel pitch ‘P’.

The heads 400R, 400G, and 400B include a plurality of red color nozzles 41 OR, a plurality of green color nozzles 41 OG, and a plurality of blue color nozzles 410B, respectively, and the nozzles are arranged at substantially equal intervals. In this case , the interval Y1 between the red color nozzles 41 OR and the green color nozzles 41 OG and the interval Y2 between the green color nozzles 41 OG and the blue color nozzles 410B may be equal.

The head unit 700 jets ink solution 5 through the nozzles 410R, 410G, and 410B while moving in the ‘x’ and ‘y’ directions using the transfer unit 300. In this case, because the size of the head unit 700 and the number of nozzles 410R, 410G, and 410B are limited, every color filter 230 is not formed through a single scanning. Therefore, the color filters 230 may be formed on the entire region of the substrate 210 by repeatedly transferring the head unit 700.

The spectrometer 800 can measure color coordinates of the color filters 230.

The spectrometer 800 will now be described with reference to FIG. 1 and FIG. 4A.

As shown in FIG. 4A, the spectrometer 800 includes a spectrum measurement part 500 and a circuit part 550.

The spectrum measurement part 500 includes a sensing part 510, a light source part 520 disposed at the lower and/or upper side(s) of the substrate 210, a spectrum part 530 for decomposing light that has passed through the color filters (not shown) formed on the substrate 210, and a processing part 540 for analyzing spectrum characteristics of light obtained by the spectrum part 530 and automatically calculating color coordinate values related to color tone, brightness, and chroma.

The circuit part 550 transfers the color coordinate information obtained from the spectrum measurement part 500 to the head unit 700, and the amount of ink solution jetted may be controlled by altering the driving voltage of the heads 400 according to the color coordinate information.

The spectrometer 800 may measure the color coordinate values of the color filters according to, for example, a transmission method or a reflection method. In the transmission method, a light source part 520 is disposed at a lower side of the stage 150 and light is transmitted to the color filters 230 through the stage 150 and the substrate 210. In this case, in order to allow light to be transmitted from the lower portion of the substrate 210, a transparent stage may be used. In the reflection method, a light source part 520 is disposed at an upper side of the substrate 210 and light provided from an upper side of the color filters is reflected and then analyzed to obtain color information. In this case, in order for light to be reflected upward from the substrate 210, rather than transmitted to the lower side of the substrate 210, a stage made of a material that is opaque and has high reflectivity may be used.

The spectrometer 800 may have a light source part 520 at both the lower and upper portions of the stage 150 so as to selectively use the transmission method and the reflection method according to usage conditions.

The transfer unit 300 includes a support 310 positioned at an upper side of the substrate 210 and spaced apart from the substrate 210, a first horizontal transfer part 330 to transfer the head unit 700 in the ‘x’ direction, a second horizontal transfer part 350 to transfer the spectrometer 800 in the ‘x’ direction, a vertical transfer part 320 to transfer the head unit 700 and the spectrometer 800 in the ‘y’ direction, a first lifter 340 to lift and lower the head unit 700, and a second lifter 360 to lift and lower the spectrometer 800.

The first horizontal transfer part 330 and the vertical transfer part 320 move the head unit 700 in the ‘x’ and ‘y’ directions, respectively, and allow ink solution to be sequentially jetted in pixels of the substrate 210. The second horizontal transfer part 350 and the vertical transfer part 320 move the spectrometer 800 in the ‘x’ and ‘y’ directions, respectively, and allow the color coordinate values of each pixel to be scanned sequentially.

The stage 150 also can be moved in the ‘x’ and ‘y’ directions by the stage driving shafts 160. Accordingly, while the head unit 700 and the spectrometer 800 are being moved in the ‘x’ and ‘y’ directions by the transfer unit 300, the substrate 210 positioned on the stage 150 can be simultaneously moved in the ‘x’ and ‘y’ directions.

A method for inspecting the color filters 230 on the substrate 210 using the inkjet printing apparatus according to the present invention will be described with reference to FIG. 1, FIG. 2, FIG. 3, FIG. 4A, and FIG. 4B as follows.

FIG. 4B is a flow chart showing the steps of a method for inspecting color filters according to one exemplary embodiment of the present invention.

First, the head unit 700 is positioned at an upper side of the substrate 210 by operating the first horizontal transfer part 330, the vertical transfer part 320, and the first lifter 340 of the inkjet printing apparatus.

Next, the first horizontal transfer part 330 and the nozzles 410R, 410G, and 410B are driven to jet ink solution 5 in the pixels while moving the head unit 700 in the ‘x’ direction.

Then, the ink solution 5 is dried to form the color filters 230. The ink solution 5 may be dried at room temperature or may be subjected to heat treatment at a relatively low temperature. Subsequently, the spectrometer 800 is positioned at an upper side of the substrate 210 by operating the second horizontal transfer part 350, the vertical transfer part 320, and the second lifter 360. At this time, the positions of pixels to which ink solution is to bejetted are detected by the sensing part 510.

Light from the light source part 520 is then irradiated to the color filters 230. When light is transmitted through the color filters 230, it is decomposed into a spectrum by the spectrum part 530. The processing part 540 calculates color coordinates using color characteristics obtained after the light is decomposed. The color characteristics include values relating to color tone, brightness, and chroma. Color coordinates of pixels scanned by a single nozzle are averaged to obtain the deviation. If the deviation is large, the corresponding information is transferred to the circuit part 550. The circuit part 550 alters the driving voltage of the head 400 according to the information received to adjust the amount of ink solution 5 jetted.

After the steps of the method are repeated, the color coordinate values of the color filters 230 are measured again using the spectrometer 800.

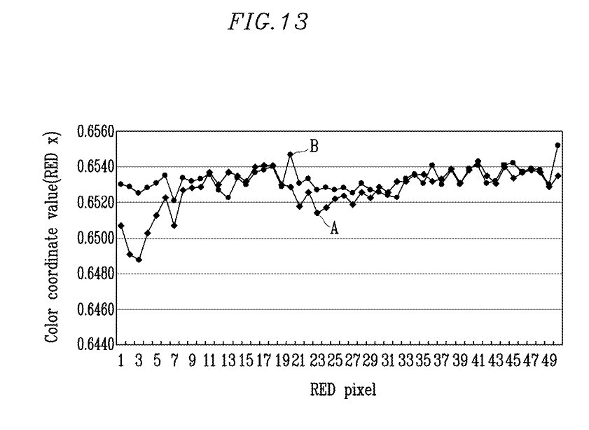

Results of the color coordinates measured in this manner are shown in FIG. 13.

FIG. 13 is a graph showing color coordinate values measured using the inkjet printing apparatus according to one exemplary embodiment of the present invention. In the experiment, red ink solution was jetted, the frequency was about 4 kHz, the printing speed was about 100 mm/s, and the opening of each pixel was about 148 μm×490 μm.

Referring to FIG. 13, the horizontal axis indicates pixel numbers scanned by a single nozzle and the vertical axis indicates color coordinate values. ‘A’ is the color coordinate values before adjustment and ‘B’ is the color coordinate values after adjustment based on information obtained by the spectrometer 800.

As noted in the graph, the adjusted color coordinate values (B) have a smaller deviation than the coordinate values (A) that are not adjusted. The deviation of the color coordinate values (A) is about 0.007, while that of (B) is about 0.004 or smaller.

In this manner, by narrowing the deviation of the color coordinate values of the color filters, colors having color coordinates within a small deviation range may be manifested from every pixel that displays the same color. Thus, the phenomenon of different colors being displayed in each pixel due to a difference in surface characteristics of partitions because of their positions and the ink jetting positions, even though the amount of ink solution jetted is the same, may be prevented, thereby reducing display stains.

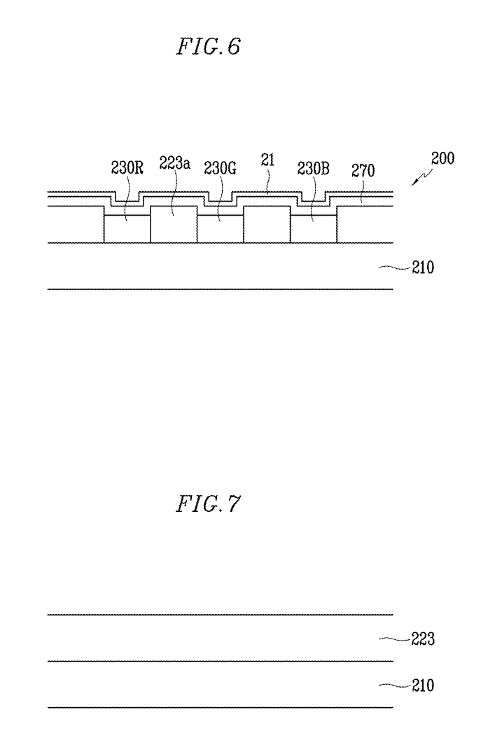

An inkjet printing apparatus according to another exemplary embodiment of the present invention will now be described with reference to FIG. 5.

FIG. 5 is a schematic perspective view showing an inkjet printing apparatus according to another exemplary embodiment of the present invention.

The inkjet printing apparatus according to the present exemplary embodiment is almost the same as that of the former exemplary embodiment of the present invention. However, the inkjet printing apparatus according to the present exemplary embodiment additionally includes a thickness measurement unit 900 for checking color characteristics of color filters 230.

The thickness measurement unit 900 is spaced apart from the spectrometer 800 and connected to a third horizontal transfer unit 370 to transfer the thickness measurement unit 900 in the ‘x’ direction and a third lifter 380 to lift and lower the thickness measurement unit 900. The thickness measurement unit 900 measures the thickness of the color filters 230.

The thickness measurement unit 900 includes a thickness measurement part (not shown) and a circuit part (not shown). The thickness measurement part measures transmittance of the color filters to calculate the thickness of the color filters, and the circuit part transfers the thickness information obtained by the thickness measurement part to the head unit 700 so that the amount of ink solution jetted may be altered by adjusting the driving voltage of the heads 400 according to the information.

The thickness measurement part includes a light source (not shown) for irradiating light from the upper and/or lower portion of the substrate 210, and the transmittance of color filters may be measured when light provided from the light source is transmitted through the color filters. The thickness of the color filters may also be obtained using the transmittance.

The transmittance (T_{CF}) and the thickness (d) have the following relationship:

T_{CF}=exp(−αd)

where α is an absorption coefficient. The thickness of the color filters may be calculated using the transmittance of the color filters obtained by the thickness measurement part. The transmittance of the color filters can be obtained by correcting transmittance of the substrate and the color filters obtained by irradiating light from the upper or lower portion of the substrate with reference to transmittance of the substrate.

Because the thickness of the color filters and the color coordinate values are proportional to each other, when the color filters are thick, the color coordinate values are generally high. Therefore, the thickness measurement unit 900 may serve to complement the spectrometer 800.

A method for forming a color filter panel using the inkjet printing apparatus will now be described with reference to FIG. 1, FIG. 2, FIG. 3, FIG. 4A, FIG. 4B, and FIG. 5.

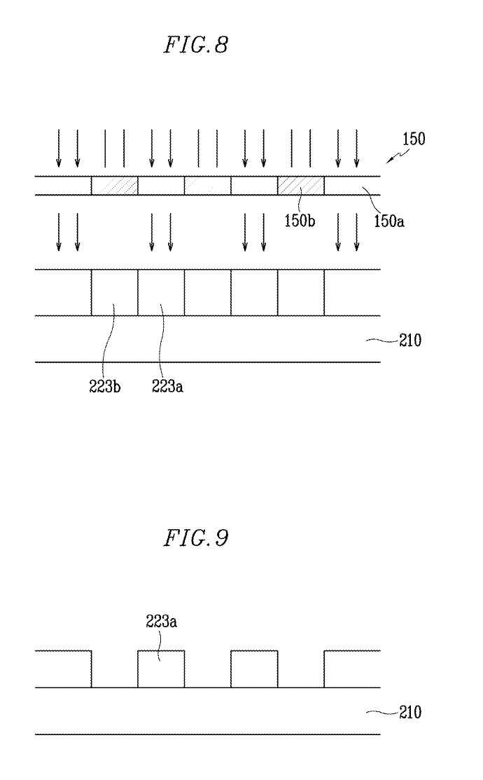

First, the color filter panel will be described with reference to FIG. 6 as follows.

FIG. 6 is a cross-sectional view showing a color filter panel according to one exemplary embodiment of the present invention.

As shown in FIG. 6, in the color filter panel 200 according to one exemplary embodiment of the present invention, a plurality of light blocking members 223a called black matrixes are formed separately at predetermined intervals on the substrate 210.

Color filters 230R, 230G, and 230B are formed between the light blocking members 223a. A common electrode 270 is formed on the light blocking members 223a and the color filters 230R, 230G, and 230B. An overcoat (not shown) for planarizing the light blocking members 223a and the color filters 230R, 230G, and 230B may be formed at a lower portion of the common electrode 270.

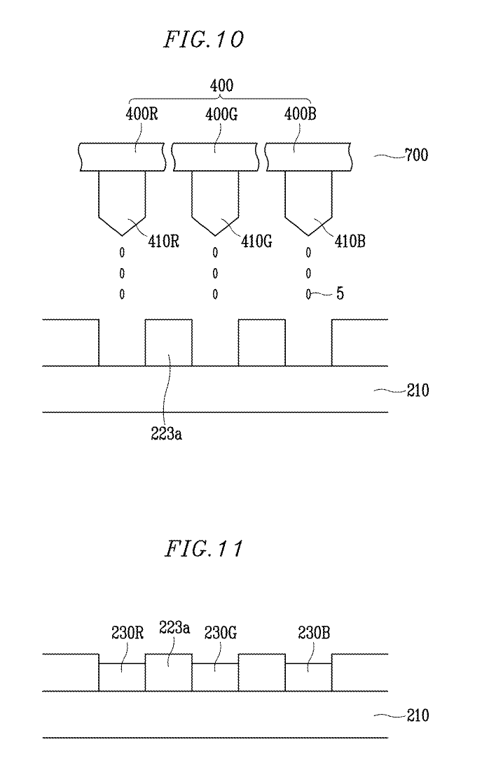

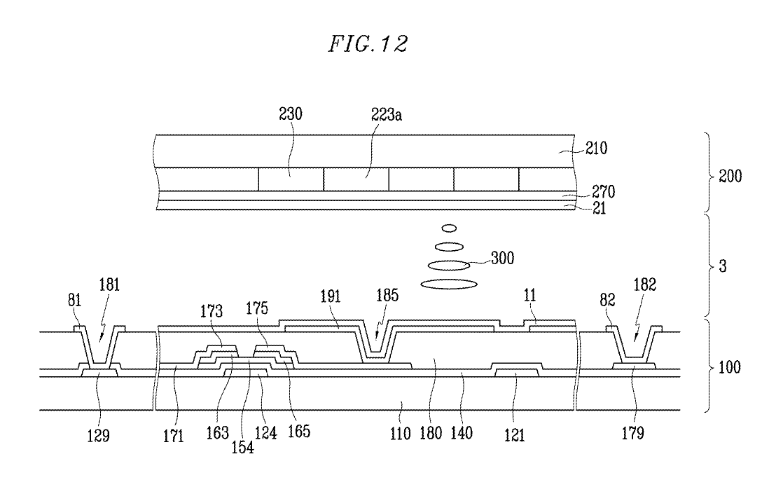

The method for fabricating the color filter panel shown in FIG. 6 will now be described with reference to FIG. 7, FIG. 8, FIG. 9, FIG. 10, FIG. 11, and FIG. 12 and also with reference to FIG. 1, FIG. 2, FIG. 3, FIG. 4A, FIG. 4B, FIG. 5, and FIG. 6.

FIG. 7, FIG. 8, FIG. 9, FIG. 10, FIG. 11, and FIG. 12 are cross-sectional views showing sequential steps of a method for manufacturing the color filter panel of FIG. 6 according to one exemplary embodiment of the present invention.

First, as shown in FIG. 7, a negative photoresist film 223 is formed on the substrate 210.

Next, as shown in FIG. 8, the photoresist film 223 is exposed to light with a wavelength of about 350 nm to 440 nm by using a mask 150 having light transmitting regions 150a and light blocking regions 150b, on which a post exposure baking is then performed for about 60 seconds to 120 seconds at a temperature of about 100° C. to 130° C. Then, through a developing process, portions 223a of the photoresist film 223 exposed through the mask 150 remain while portions 223b of the photoresist film that have not been exposed are removed.

Thereafter, with reference to FIG. 9, the non-exposed portions 223b of the photoresist film are developed using a 2.38% TMAH solution, and the remaining portions 223a of the photoresist film are cured to form the plurality of light blocking members 223a. The light blocking members 223a serve as partitions.

With reference to FIG. 10, the inkjet printing apparatus is disposed above the substrate 210 on which the light blocking members 223a have been formed. The inkjet printing apparatus includes the head unit 700 including the plurality of heads 400R, 400G, and 400B and the plurality of nozzles 410R, 410G, and 410B formed at the lower surfaces of the respective heads 400R, 400G, and 400B, and the spectrometer 800. The nozzles 410R, 410G, and 410B are disposed between the light blocking members 223a to jet the ink solution 5 for the color filters.

Then, the ink solution 5 is dried to form the color filters 230R, 230G, and 230B between the light blocking members 223a, as shown in FIG. 11.

Subsequently, the color coordinate values of the color filters 230R, 230G, and 230B are measured using the spectrometer 800. When the deviation of the measured color coordinate values is within a predetermined range, formation of the color filters 230 is completed. If the deviation of the measured color coordinate values is beyond the predetermined range, the corresponding information is transferred to the head unit 700 to alter the driving voltage of the heads 400 to adjust the amount of ink solution 5 jetted.

With reference to FIG. 6, the common electrode 270 is formed on the light blocking members 223a and the color filters 230R, 230G, and 230B, and an alignment layer 21 is formed on the common electrode 270. Also, an overcoat (not shown) for planarizing the light blocking members 223a and the color filters 230R, 230G, and 230B may additionally be formed before forming the common electrode 270.

With reference to FIG. 12, the manufactured color filter panel 200 faces a thin film transistor (TFT) array panel 100.

FIG. 12 is cross-sectional view showing an LCD including the color filter panel of FIG. 6.

The TFT array panel 100 includes a substrate 110, gate lines 121 including gate electrodes 124 and end portions 129, a gate insulating layer 140 formed on the gate lines 121, semiconductors 154 formed at upper portions of the gate electrodes 124, ohmic contacts 163 and 165 formed on the semiconductors 154, data lines 171 formed on the semiconductors 154 and including source electrodes 173 and end portions 179, drain electrodes 175 that face the source electrodes 173 at the upper portions of the semiconductors 154, a passivation layer 180 having a plurality of contact holes 181, 182, and 185, pixel electrodes 191 connected to the drain electrodes 175 via the contact holes 185, contact assistants 81 and 82 connected to the end portions 129 of the gate lines 121 and the end portions 179 of the data lines 171 via the contact holes 181 and 182, respectively, and an alignment layer 11 formed thereon. A liquid crystal layer 3 including a plurality of liquid crystal molecules 300 is injected between the TFT array panel 100 and the color filter panel 200 to complete an LCD.

As so far described, in the present invention, by reducing the deviation of the color coordinate values or the thicknesses of the color filters, color filters having color coordinate values or thicknesses within a small deviation range can be formed in every pixel displaying the same color. Accordingly, the phenomenon of different colors being displayed in each pixel after the ink is dried, even though the amount of ink solution jetted for each color filter is the same, may be prevented, thereby reducing display stains.

It will be apparent to those skilled in the art that various modifications and variations can be made in the present invention without departing from the spirit or scope of the invention. Thus, it is intended to that the present invention cover the modifications and variations of this invention provided they come within the spirit and scope of the appended claims and their equivalents.

What is claimed is:

1. An inkjet printing apparatus, comprising:
a stage adapted to receive a substrate;
an inkjet head to jet ink solution for color filters onto the substrate; and
a color coordinate measurement unit spaced apart from the inkjet head to measure color coordinates of the color filters.

2. The apparatus of claim 1, wherein the color coordinate measurement unit is a spectrometer.

3. The apparatus of claim 2, wherein the spectrometer comprises:
a spectrum measurement part to measure the color coordinates of the color filters, and
a circuit part to transfer information of the color coordinates to the inkjet head to control the amount of ink solution jetted.

4. The apparatus of claim 3, further comprising:
a transfer unit to move the inkjet head and the spectrometer.

5. The apparatus of claim 4, further comprising:
a thickness measurement unit moveable by the transfer unit and spaced apart from the inkjet head and the spectrometer.

6. The apparatus of claim 5, wherein the thickness measurement unit comprises:
a thickness measurement to measure the thickness of the color filters, and
a circuit part to transfer the thickness information to the inkjet head to adjust the amount of ink solution jetted.

7. A method for inspecting color filters, comprising:
disposing a substrate on an inkjet printing apparatus having an inkjet head and a color coordinate measurement unit;
jetting ink solution onto the substrate;
drying the ink solution to form color filters;
measuring color coordinates of the color filters with the color coordinate measurement unit; and
controlling the amount of ink solution jetted based on the color coordinate measurements.

8. The method of claim 7, wherein spectrum characteristics are used in measuring the color coordinates of the color filters.

9. The method of claim 7, wherein color coordinates of a plurality of pixels are measured by moving a spectrometer from one side of the substrate to the other side of the substrate.

10. The method of claim 9, wherein, after measuring the color coordinates, the color coordinates of the plurality of pixels are normalized, and a driving voltage of the inkjet head is adjusted based on the normalized color coordinates.

11. A method for manufacturing a color filter panel, comprising:
forming an insulating layer comprising a plurality of openings on a substrate;
disposing an inkjet head over the openings and jetting ink solution;
drying the ink solution to form color filters;
measuring color coordinates of the color filters; and
forming electrodes on the color filters.

12. The method of claim 11, wherein color coordinates of a plurality of pixels are measured by moving a spectrometer from one side of the substrate to the other side of the substrate.

13. The method of claim 12, wherein, after measuring the color coordinates, the color coordinates of the plurality of pixels are normalized, and a driving voltage of the inkjet head is adjusted based on the normalized color coordinates.

14. The method of claim 11, wherein the insulating layer is light blocking member.
